(19) United States
(12) Patent Application Publication
(10) Pub. No.: US 2024/0116454 A1
(43) Pub. Date: Apr. 11, 2024

(54) Catalytic Converter Guard System

(71) Applicant: Monroe Truck Equipment, Inc., Monroe, WI (US)

(72) Inventors: Daniel Nommensen, Monroe, WI (US); Eric Falsey, Monroe, WI (US)

(21) Appl. No.: 18/482,583

(22) Filed: Oct. 6, 2023

Related U.S. Application Data
(60) Provisional application No. 63/413,680, filed on Oct. 6, 2022.

(51) Int. Cl. B60R 11/00

(52) U.S. Cl. CPC B60R 11/00; B60R 2011/004; B60R 2011/0096

(57) ABSTRACT

Catalytic converter guard systems and related methods are provided for inhibiting access to a catalytic converter on a motor vehicle. The catalytic converter guard can include a set of mounting brackets and a cage. The set of mounting brackets can be coupled to a frame rail of the motor vehicle to at least partly surround the catalytic converter with the cage.

### CROSS-REFERENCE TO RELATED APPLICATIONS

This application claims priority to U.S. provisional patent application No. 63/413,680, filed Oct. 6, 2022, the entirety of which is incorporated herein by reference.

### BACKGROUND

Catalytic convertors are an important component of a motor vehicle's exhaust system. They aid in converting harmful substances in a motor vehicle's exhaust gases, like carbon monoxide, nitric oxide, nitrogen dioxide, and hydrocarbons into less harmful substances such as carbon dioxide and water vapor through catalysis using precious metals such as platinum, palladium, and rhodium. Catalytic converters are typically located underneath the body of the motor vehicle and can therefore be fairly easily accessible, including for unauthorized personnel.

### SUMMARY

Some embodiments of the invention provide a catalytic converter guard system for inhibiting access to a catalytic converter on a motor vehicle. The catalytic converter guard system can include a set of mounting brackets and a cage. The cage can include an input guard plate with a first cutout, an output guard plate with a second cutout, and a bottom plate coupled to the input guard plate and the output guard plate. The set of mounting brackets can be coupled to the cage and configured to couple to a frame of a motor vehicle to support the cage relative to the motor vehicle so that the input guard plate is positioned adjacent an input of the catalytic converter to align the first cutout to receive an input exhaust pipe therethrough, the output guard plate is positioned adjacent an output of the catalytic converter to align the second cutout to receive an output exhaust pipe therethrough, and the bottom plate is positioned to extend beneath the catalytic converter

Some embodiments of the invention provide a catalytic converter guard system for protecting a catalytic converter on a motor vehicle. The catalytic converter guard system can include a plurality of tamper-resistant fasteners and a catalytic converter guard that includes a set of mounting brackets, and a bottom wall coupled to the set of mounting brackets. The catalytic converter guard can be secured to the motor vehicle, with at least one mounting bracket of the set of mounting brackets coupled to a frame rail of the motor vehicle with the plurality of tamper-resistant fasteners and the bottom wall extending beneath the catalytic converter.

Some embodiments of the invention provide a catalytic converter guard for protecting a catalytic converter on a motor vehicle. The catalytic converter guard can include a five-sided box, including four side walls and a bottom wall, and a set of mounting brackets. The set of mounting brackets can be positioned within the five-sided box, can be secured to the bottom wall, and, with the catalytic converter guard installed on the motor vehicle, can be secured to a frame rail of the motor vehicle.

Some embodiments of the invention provide a method of installing a catalytic converter guard system to protect a catalytic converter on a motor vehicle. A set of mounting brackets can be coupled to a cage of a catalytic converter guard, the cage including an input guard plate with a first cutout, an output guard plate with a second cutout, and a bottom plate coupled to the input guard plate and the output guard plate. The set of mounting brackets can be coupled to a frame of the motor vehicle to support the cage relative to the motor vehicle. With the set of mounting brackets coupled to the cage and to the frame of the motor vehicle, the input guard plate can be positioned adjacent an input of the catalytic converter to align the first cutout to receive an input exhaust pipe therethrough, the output guard plate can be positioned adjacent an output of the catalytic converter to align the second cutout to receive an output exhaust pipe therethrough, and the bottom plate can be positioned to extend beneath the catalytic converter

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a rear top left isometric view of a catalytic converter guard according to an embodiment of the invention;

FIG. 2 is a front top right isometric view of the catalytic converter guard of FIG. 1;

FIG. 3 is a top plan view of the catalytic converter guard of FIG. 1;

FIG. 4 is an exploded view of the catalytic converter guard of FIG. 1;

FIG. 5 is rear top left isometric view of the catalytic converter guard of FIG. 1 installed on a motor vehicle frame with an exhaust system;

FIG. 6 is a rear view of a mounting bracket of the catalytic converter guard of FIG. 1 installed on a motor vehicle frame according to an embodiment of the invention;

FIG. 7 is a rear top left isometric view of a catalytic converter guard according to another embodiment of the invention;

FIG. 8 is a front top right isometric view of the catalytic converter guard of FIG. 7;

FIG. 9 is a top plan view of the catalytic converter guard of FIG. 7; and

FIG. 10 is an exploded view of the catalytic converter guard of FIG. 7; and

FIG. 11 is a rear view of a mounting bracket of the catalytic converter guard of FIG. 7 installed on a motor vehicle frame according to an embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

As generally noted above, catalytic converters are typically installed in relatively accessible locations on vehicles. Unfortunately, it has become more and more common for catalytic converters to be forcibly removed from motor vehicles because of the scrap value of the precious metals. Due to the relative ease of access to areas below a vehicle chassis, a thief can simply crawl under a motor vehicle and remove a catalytic converter from the exhaust system by cutting the input and output exhaust pipes on either side of the catalytic converter.

Correspondingly, in some contexts, it may be useful to protect a catalytic converter on a motor vehicle from being forcibly removed (e.g., via sawing the exhaust pipes on either end). Further, it may be useful to install a catalytic converter guard on a motor vehicle as an aftermarket add-on. Embodiments of the invention can be useful for this purpose, and others. For example, embodiments of the invention can be used to cover a catalytic converter to prevent removal of the catalytic converter, even when both ends of the catalytic converter are cut from their connection with the exhaust system. As another example, some embodiments of the invention can be positioned around the catalytic converter from below the motor vehicle and secured to the frame with mounting brackets and/or fasteners. In some embodiments, the fasteners can be tamper-resistant fasteners, which may require special tools for installation and removal.

In some embodiments, a catalytic converter guard can include a set of mounting brackets that are configured to be secured to the frame of a motor vehicle. In some embodiments, the mounting brackets have holes for receiving fasteners. The fasteners may couple the bracket to a frame of the motor vehicle. In some embodiments, the catalytic converter guard can have guard plates positioned to the front, rear, right and left sides of the catalytic converter, wherein front and rear positions with respect to the catalytic converter are in relation to the front and rear of the motor vehicle, respectively, and left and right positions with respect to the catalytic converter are in relation to the driver and passenger sides of the motor vehicle, respectively. In some embodiments, the catalytic converter guard can have a bottom plate adjoining the guard plates and extending underneath the catalytic converter. The guard plates and the bottom plate can be formed to accommodate various shapes, sizes, and locations of the catalytic converter and frame members.

In some embodiments, a catalytic converter guard can be configured to reduce the drag imposed on the motor vehicle, as compared to conventional arrangements. For example, apertures can be provided throughout to allow air to pass through the catalytic converter guard. The apertures can also aid in removing heat generated by exhaust gasses passing through the catalytic converter. Additionally, the removal of material from a catalytic converter guard reduces the weight. The reduction of drag and weight can increase fuel efficiency.

In some conventional arrangements, catalytic converter protective devices are configured to accommodate a single catalytic converter through a secured clamp or a similarly dimensioned cage secured to a body panel, such as, for example, a floor board. This can increase the likelihood for water penetration at the fastening locations and can eventually lead to the floor board (or other body panel) rusting and failing at those locations.

Some embodiments of the invention can address this issue, or others. For example, some embodiments of the invention are presented below in the context of a catalytic converter guard for protecting a catalytic converter, wherein the catalytic converter guard is mounted to a frame member. Generally, the principles disclosed herein can be used with any variety of catalytic converter configurations and/or motor vehicle frame configurations.

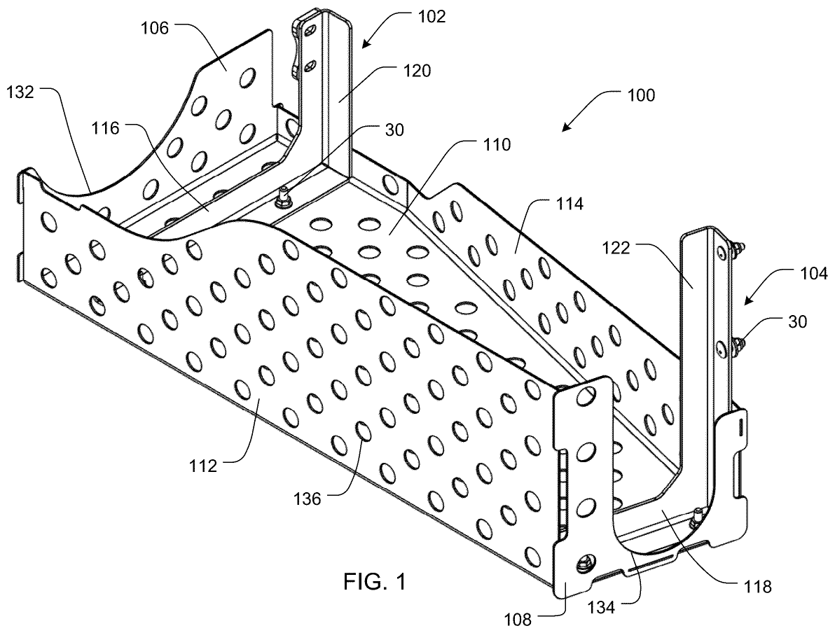

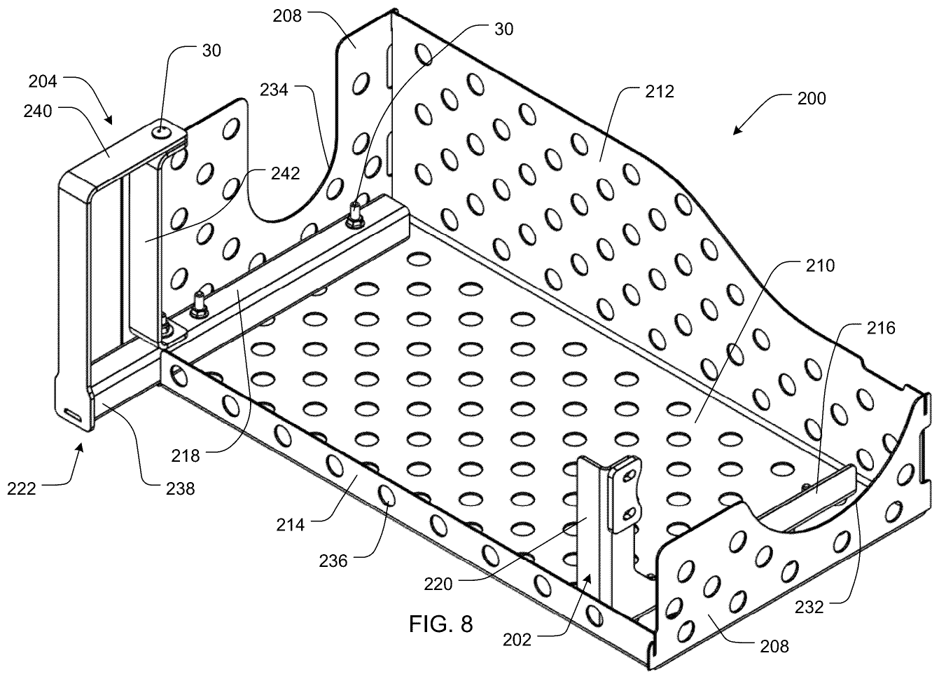

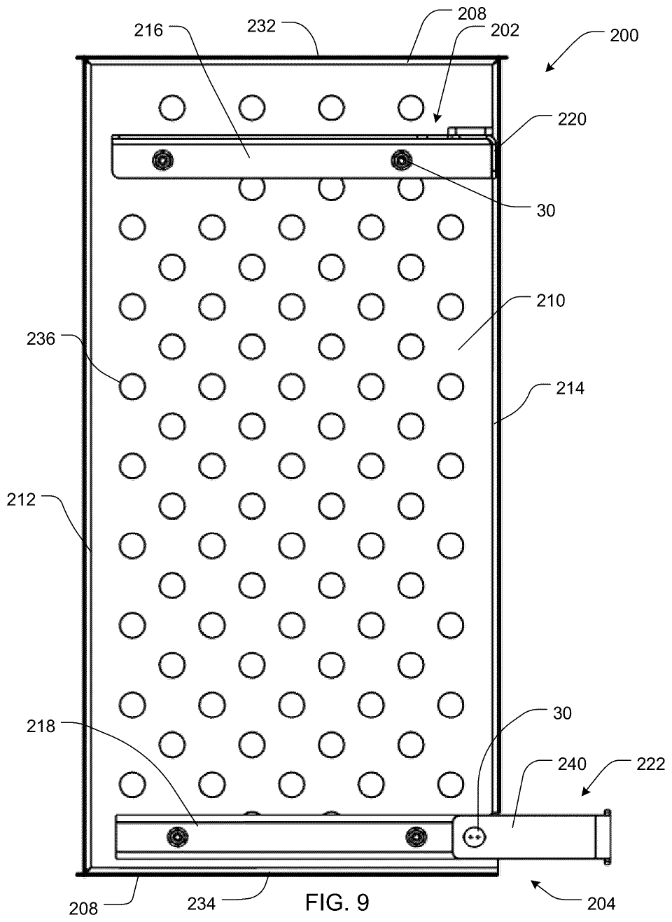

With regard to construction, various embodiments can be readily formed from a variety of known manufacturing techniques, including bending sheet metal. For example, some embodiments, including the embodiments illustrated in the FIGS. 1-11, can be stamped as one piece and bent to form. In other embodiments, multiple pieces can be stamped and joined together through methods such as welding or with fasteners.

FIGS. 1 through 5 illustrate an embodiment of a catalytic converter guard 100 configured to be mounted to a frame 10 of a body-on-frame motor vehicle (not shown) with an exhaust system 12. It is contemplated, however, that in some embodiments, a catalytic converter guard with the same or similar elements and attributes could be configured to be installed on a motor vehicle with a unibody frame.

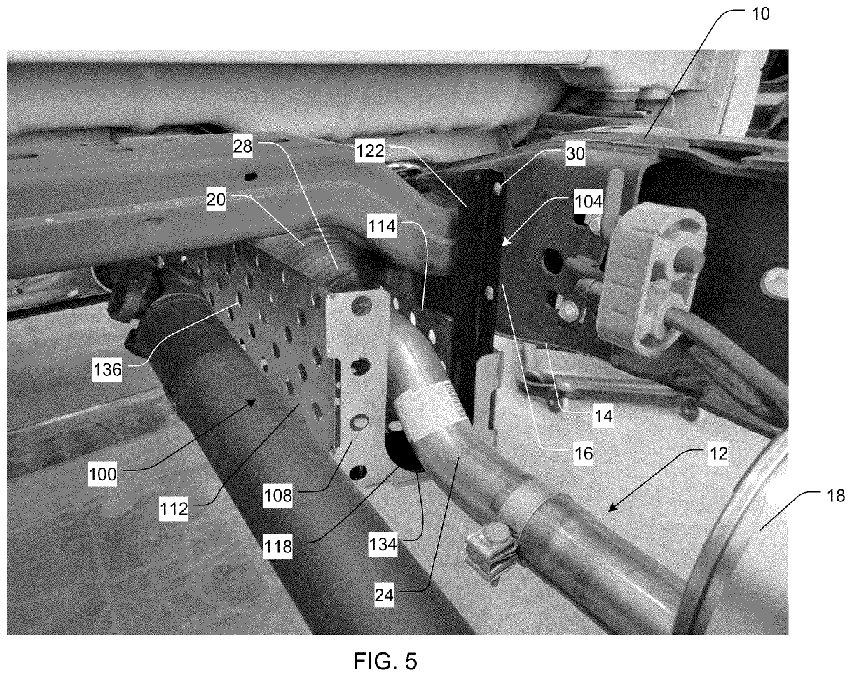

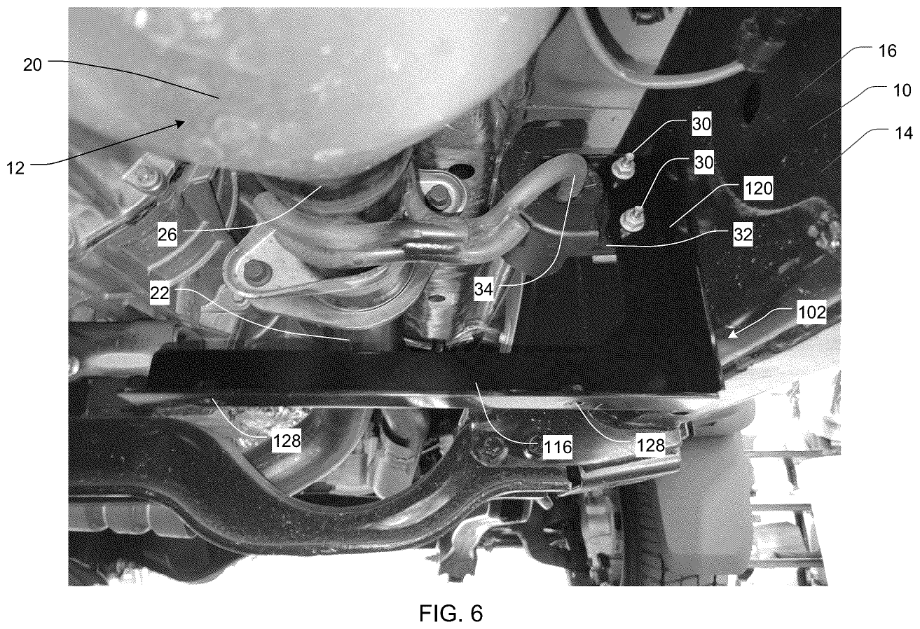

The frame 10 has a set of rails including a first rail 14 with an inboard-facing side 16 (shown in FIGS. 5 and 6) and a second rail (not shown). The exhaust system 12, shown here as an example exhaust system, has a muffler 18 (shown in FIG. 5), a catalytic converter 20, an input exhaust pipe 22 (shown in FIG. 6), and an output exhaust pipe 24. The input exhaust pipe 22 extends between an exhaust manifold (not shown) and a first end 26 of the catalytic converter 20. The output exhaust pipe 24 is coupled to and between a second end 28 of the catalytic converter 20 and the muffler 18. It should be noted that other exhaust systems, including, for example, systems with dual mufflers, systems with a set of catalytic converters, and other similar configurations are contemplated for use with the catalytic converter guard 100.

Continuing, the catalytic converter guard 100 is shown in FIG. 5 mounted to the frame 10 and enclosing the catalytic converter 20. The catalytic converter guard 100 includes a set of mounting brackets, including a first mounting bracket 102 and a second mounting bracket 104 (e.g., L-shaped brackets, as shown). The catalytic converter guard also generally includes a cage to at least partly surround a catalytic converter, e.g., with an input guard plate 106, an output guard plate 108, a bottom plate 110, a left (e.g., inboard) guard plate 112, and a right (e.g., outboard) guard plate 114, as shown (although different numbers or geometries of cage sides are possible). The first and second mounting brackets, can be L-shaped as shown, each with a horizontal leg 116, 118 and a vertical leg 120, 122 sized and configured for attachment to the bottom plate 110 and the frame 10, respectively. However, other configurations capable of providing securement to the frame are contemplated.

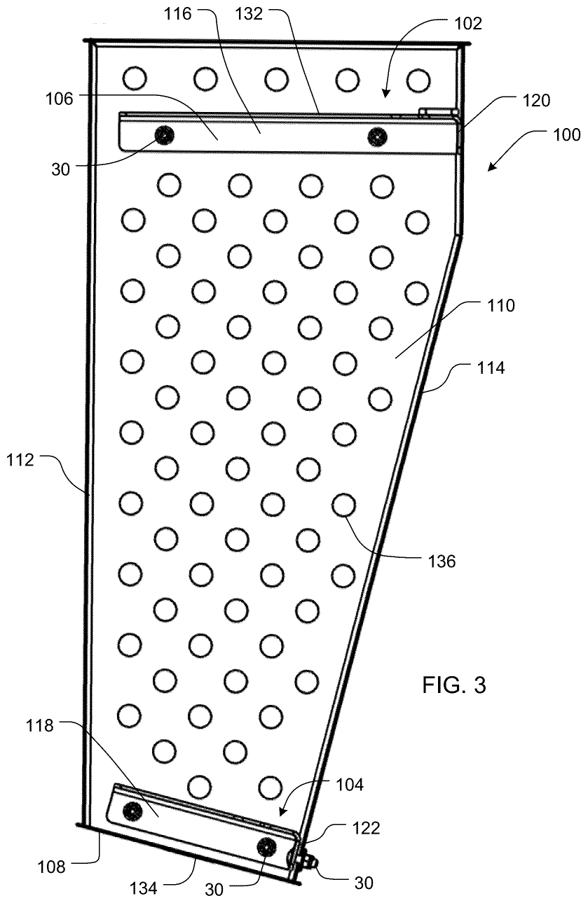

As shown, the input and output guard plates 106, 108, the bottom plate 110, and the left and right guard plates 112, 114 can be integrally formed from a single piece of sheet metal stamped and bent to form. However, in some embodiments, one or more of the parts of the catalytic converter guard 100 may be welded or otherwise secured together, including with tamper-resistant fasteners, stamped tabs, or other forms of securement. In some embodiments, the form of the catalytic converter guard 100 can generally be a box-shape with four side walls (i.e., the input and output guard plates 106, 108 and the left and right guard plates 112, 114), a bottom wall (i.e., the bottom plate 110), and an open top. Further, the catalytic converter guard 100 can be dimensioned and/or shaped to accommodate the configuration of components and structural members beneath the motor vehicle. For example, as shown in FIG. 3, the right guard plate 114 may extend from the input guard plate 106 at approximately a right angle. In some embodiments, the right guard plate 114 may be bent obliquely to accommodate a bend in the first rail 14.

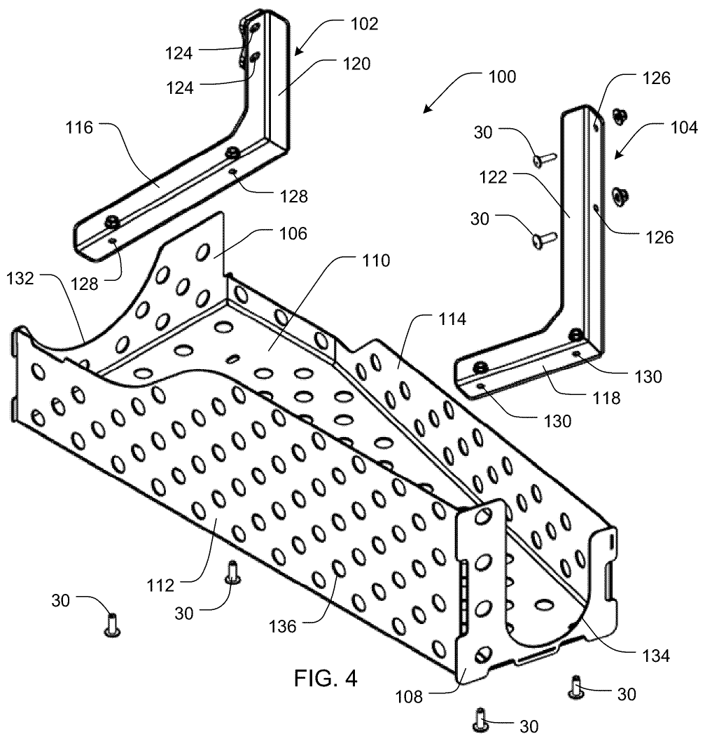

The catalytic converter guard 100 can be secured to the first rail 14 of the frame 10 with tamper-resistant fasteners 30. As shown in FIG. 6, the first mounting bracket 102 is positioned with the vertical leg 120 adjacent the inboard-facing side 16 of the first rail 14. The vertical leg 120 may include a set of mounting holes 124 (shown in FIG. 4) through which the tamper-resistant fasteners 30 are received. In some embodiments, the fasteners 30 may extend through holes (not shown) in the first rail 14. In some embodiments, the fasteners 30 may extend through holes (hidden) in a mounting flange 32 extending from the inboard-facing side 16 of the first rail 14. As illustrated in FIG. 6 the fasteners 30 may also receive a hanger 34 for the exhaust system 12, to secure the first mounting bracket 102 to the first rail 14. Example tamper-resistant fasteners can include tamper-resistant Torx-head fasteners, tamper-resistant drilled spanner-head fasteners, tamper-resistant one-way fasteners, and two-hole (“pig-nose”) fasteners. (Torx is a registered trademark of Acument Intellectual Properties, LLC in the United States or other jurisdictions.)

Similar to the first mounting bracket 102, the vertical leg 122 of the second mounting bracket 104 is positioned adjacent the inboard-facing side 16 of the first rail 14 (shown in FIG. 5). The vertical leg 122 may include a set of mounting holes 126 (shown in FIG. 4) configured to receive the tamper-resistant fasteners 30, that may couple the vertical leg 122 to the first rail 14.

In some embodiments, the first mounting bracket 102 and the second mount bracket 104 may alternatively be permanently fastened to the frame 10. For example, the first and second mounting brackets 102, 104 may be welded to the frame 10.

Continuing, as shown in FIGS. 1 through 3, the first and second mounting brackets 102, 104 are positioned within the box-like structure formed by the input and output guard plates 106, 108, the left and right guard plates 112, 114, and the bottom plate 110. The horizontal legs 116, 118 of the first and second mounting brackets 102, 104 are configured to be secured to the bottom plate 110 with tamper-resistant fasteners 30 extending through respective sets of mounting holes 128, 130 (shown in FIG. 4).

In some embodiments, the first mounting bracket 102 and the second mounting bracket 104 may alternatively be permanently fastened to the bottom plate 110. For example, the first and second mounting brackets 102, 104 may be welded to the bottom plate 110. In some embodiments, the first mounting bracket 102 and the second mounting bracket 104 may alternatively be fastened to a bottom of the bottom plate 110, such that the bottom plate 110 rests on a top of the horizontal legs 116, 118.

Generally, the mounting brackets 102, 104 can extend from the cage of the guard 100 adjacent to the right (e.g., outboard) guard plate 114. In some embodiments, the vertical leg 120, 122 may be coupled to the left or right guard plate 112, 114 or to the input or output guard plate 106, 108. In some embodiments, the vertical leg 120, 122 secured to the left or right guard plate 112, 114 may not include the horizontal leg 116, 118. Such a configuration may save weight and material costs while also increasing the difficulty of accessing or removing the fasteners 30, for a potential thief. In some embodiments, the first mounting bracket 102 and the second mounting bracket 104 may be integrally formed or stamped with the catalytic converter guard 100. For example, the first mounting bracket 102 and the second mounting bracket 104 may extend from the left or right guard plate 112, 114 or the input or output plates 106, 108.

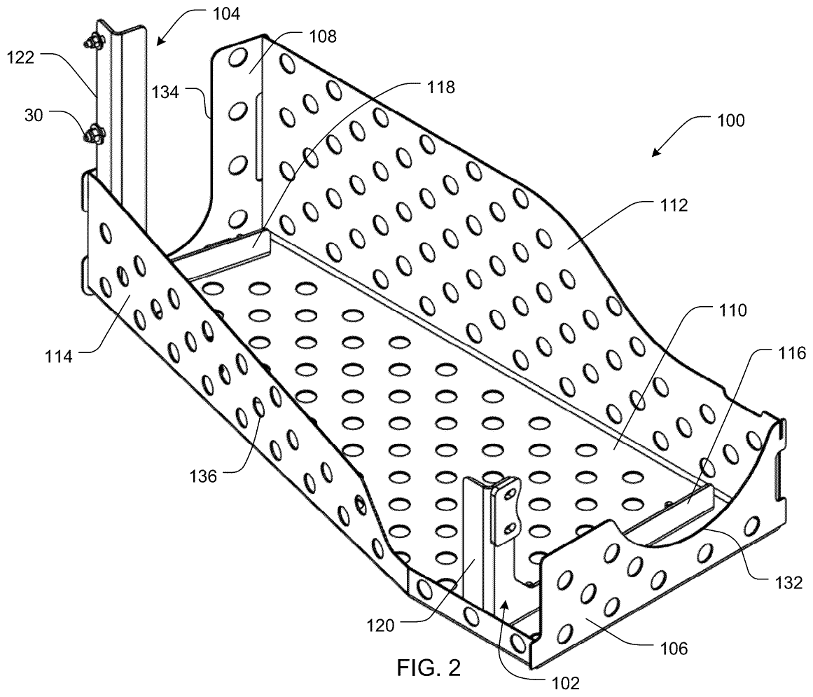

The input and output guard plates 106, 108 can be seen in FIGS. 1 and 2. The input and output guard plates 106, 108 extend between the left and right guard plates 112, 114. When installed on the motor vehicle, the input guard plate 106 is positioned between the exhaust manifold and the first end 26 of the catalytic converter 20. The input guard plate 106 is located adjacent (i.e., near, close to, or next to, but not necessarily touching) the first end 26 with the input exhaust pipe 22 located generally exterior to the catalytic converter guard 100. The input guard plate 106 may include an input cutout 132. The input cutout 132 is positioned adjacent the first end 26 of the catalytic converter 20 and is shaped to permit the input exhaust pipe 22 to pass therethrough. In some embodiments, the input cutout 132 may curve concavely from a top of the input guard plate 106 toward the bottom plate 110. The curved shape of the input cutout 132 may aid the reception of the cylindrical input exhaust pipe 22. In some embodiments, the input cutout 132 may be any shape that may permit the input exhaust pipe 22 to pass therethrough (e.g., triangular, rectangular, etc.) but prevent passage of the catalytic converter 20 itself. In some embodiments, more or fewer input cutouts can be provided depending on the configuration of the exhaust system or the placement of other systems beneath the motor vehicle.

Generally, cutouts on guard plates can be configured to accommodate passage of relevant exhaust system (or other) components, including as illustrated in the various FIGS. In some cases, a depth of cutouts can be sufficiently large so that a catalytic converter guard (e.g., the guard 100, as illustrated) can accommodate passage of the relevant components while not increasing the required clearance to ground relative to the relevant exhaust system without the guard. Moreover, the cutouts on guard plates, including as shown for the input cutout 132, can exhibit one or more maximum dimensions that are generally less than one or more corresponding maximum dimensions of a catalytic converter, so that even if all of the relevant exhaust pipes are cut, the catalytic converter may still not be removable via the cutouts.

Continuing, the output guard plate 108 is positioned between the second end 28 of the catalytic converter 20 and the muffler 18. As illustrated in FIG. 5, the output guard plate 108 is located adjacent (i.e., near, close to, or next to, but not necessarily touching) the muffler 18 with a portion of the output exhaust pipe 24 located generally inside the catalytic converter guard 100. Further, the output guard plate 108 can include an output cutout 134. The output cutout 134 is positioned adjacent the muffler 18 and is shaped to permit the output exhaust pipe 24 to pass therethrough. In some embodiments, the output cutout 134 may curve concavely from a top of the output guard plate 108 toward the bottom plate 110. The curved shape of the output cutout 134 may aid the reception of the cylindrical output exhaust pipe 24. In some embodiments, the output cutout 134 may be any shape that may permit the output exhaust pipe 24 to pass therethrough (e.g., triangular, rectangular, etc.) but prevent passage of the catalytic converter 20 itself. In some embodiments, more or fewer output cutouts can be provided depending on the configuration of the exhaust system or the placement of other systems beneath the motor vehicle.

In order to accommodate various shapes and sizes of the catalytic converter 20, a shape of the left and right guard plates 112, 114 may vary between the input and output guard plates 106, 108. In some embodiments, a height of the left and right guard plates 112, 114 may vary to accommodate various features of the frame 10 and the catalytic converter 20. In some embodiments, the right guard plate 114 may be shorter than the left guard plate 112. As illustrated in FIG. 5, a portion of the catalytic converter 20 may be shielded by the first rail 14. As such, the right guard plate 114 may be shorter to reduce a weight of the catalytic converter guard 100.

Looking at FIGS. 1 and 2, the input and output guard plates 106, 108 and the left and right guard plates 112, 114 are shown all coupled to the bottom plate 110. The bottom plate 110 can be a planar piece of material, however, other configurations are contemplated depending on the location of components of the motor vehicle drivetrain and the exhaust system to avoid interference therewith.

Additionally, the catalytic converter guard 100 can include ventilation features to allow airflow therethrough. As shown in FIGS. 1 through 5, each of the input and output guard plates 106, 108, the left and right guard plates 112, 114, and the bottom plate 110 have a plurality of apertures 136. In some embodiments, the apertures 136 can have other shapes and sizes (e.g., elongate slots, diamonds, rectangles, etc.). The apertures 136 can allow airflow through the catalytic converter guard 100 and allow the heat of exhaust gases to vent outboard and away from underneath the motor vehicle. Further, the apertures 136 can provide a path for water or other debris to exit the catalytic converter guard 100. The apertures 136 can also decrease the drag induced by the catalytic converter guard 100 as the motor vehicle is traveling. Finally, the apertures 136 may decrease a weight of the catalytic converter guard 100. The combined reduction of drag and weight may reduce the impact the catalytic converter guard 100 may have on fuel efficiency.

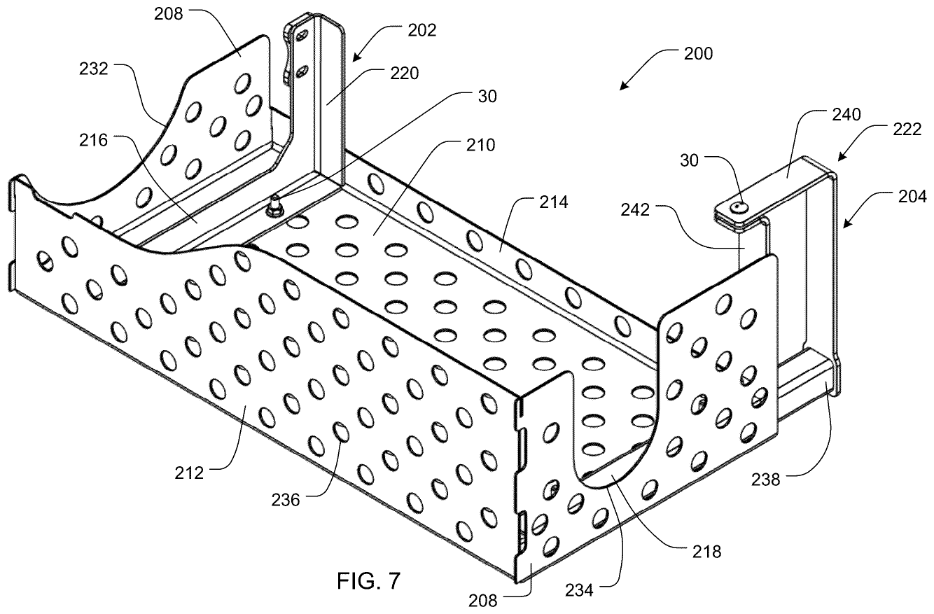

FIGS. 7 through 11 illustrates another embodiment of a catalytic converter guard 200, or aspects thereof, according to the invention, as also can prevent access to a catalytic converter and can be secured to a frame rail (or other frame structure) of a motor vehicle. In many aspects, the catalytic converter guard 200 is similar to the catalytic converter guard 100 described above. Correspondingly, discussion of the guard 100 above generally applies relative to the guard 200 (and vice versa) and similar numbering in the 200 series is used for the catalytic converter guard 200. For example, the catalytic converter guard 200 has a first mounting bracket 202, with a horizontal leg 216 and a vertical leg 220 and respective mounting holes 228, 224, a second mounting bracket 204, with a horizontal leg 218, an input guard plate 206 with an input cutout 232, an output guard plate 208 with an output cutout 234, a bottom plate 210, a left guard plate 212, a right guard plate 214, and apertures 236 throughout.

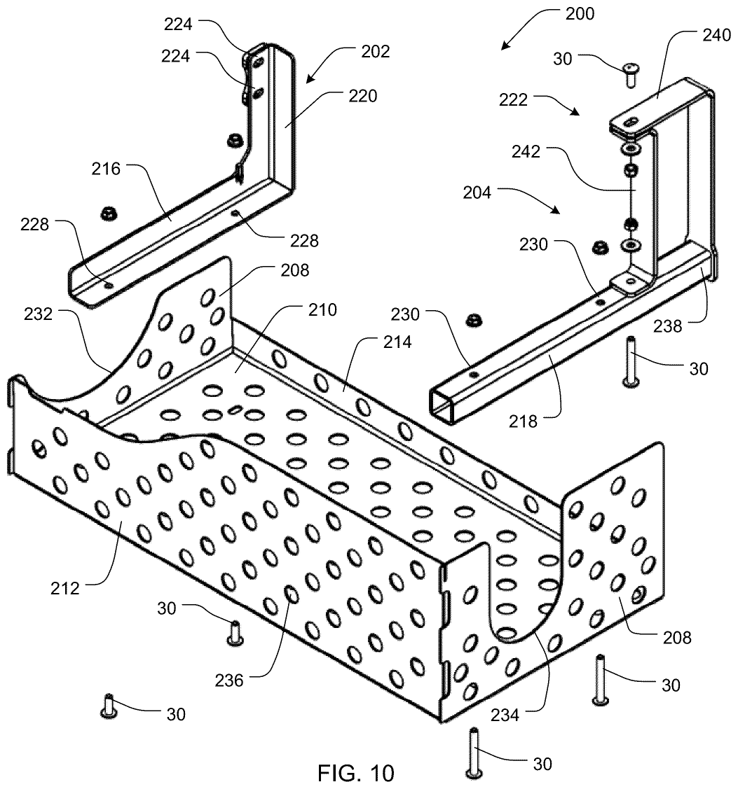

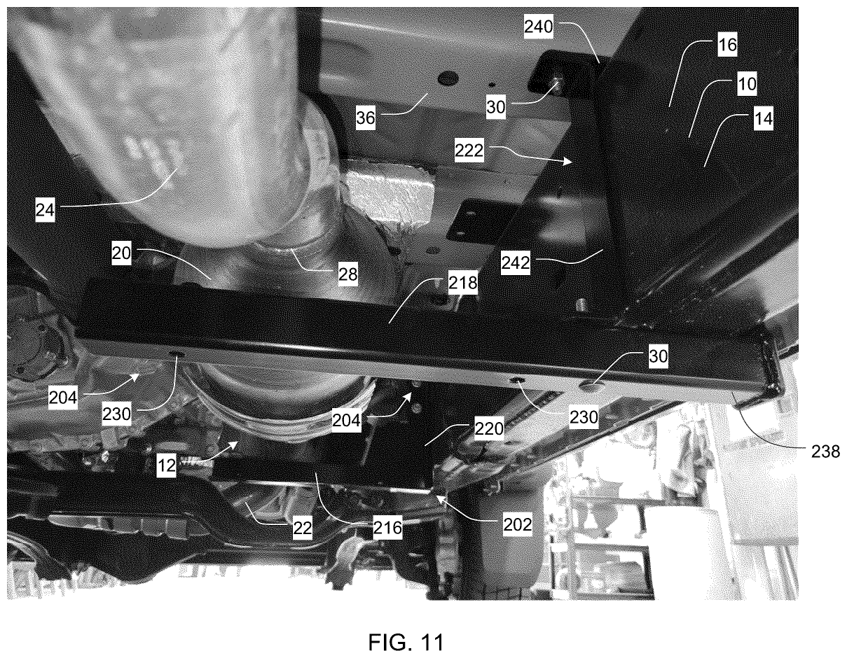

In some aspects, however, the catalytic converter guards 100, 200 differ from each other. For example, the second mounting bracket 204 is configured to be mounted around the first rail 14 and to be secured to a body structural member 36 (shown in FIG. 11). The second mounting bracket 204 has a horizontal leg 218 (here shown made from a piece of square tubing), with mounting holes 230 (see FIG. 10), and a vertical leg assembly 222. The horizontal leg 218 has an external end 238 that extends outboard beyond the right guard plate 214 and is configured to extend under and beyond the first rail 14 (see FIG. 11).

The vertical leg assembly 222 is configured to permit the installation of the second mounting bracket 204 to the first rail 14 without requiring any modification or alteration to the motor vehicle, including the removal of elements therefrom to provide access to the first rail 14. As shown in the FIGS. 7-11, the vertical leg assembly 222 includes a fixed section 240 and a removable section 242. The fixed section 240 is coupled to and extends upward from the external end 238 of the horizontal leg 216 and is formed to extend alongside an outboard-facing side (hidden) and over a top side (hidden) of the first rail 14. The removable section 242 is configured to extend alongside the inboard-facing side 16 of the first rail 14 and be removably attached to and between the fixed section 240 and the horizontal leg 216. As shown, the connection point between the fixed section 240 and the removable section 242 also provides a point to secure the vertical leg assembly 222 to the body structural member 36 with a tamper-resistant fastener 30.

In other embodiments, other configurations are possible. For example, certain features and combinations of features that are presented with respect to particular embodiments in the discussion above can be utilized in other embodiments and in other combinations, as appropriate. In this regard, for example, different configurations of engagement features, attachment mechanisms, and so on, as presented with respect to a particular one of the catalytic converter guards 100, 200 can be implemented in combination with features of any number of the other catalytic converter guards 100, 200, or others. Additionally, the different configurations of the catalytic converter guards 100, 200 may lend themselves to different configurations of motor vehicles (e.g., single cab, extended cat, etc.).

In some implementations, devices or systems disclosed herein can be utilized or installed using methods embodying aspects of the invention. Correspondingly, description herein of particular features or capabilities of a device or system is generally intended to inherently include disclosure of a method of using such features for intended purposes and of implementing such capabilities. Similarly, express discussion of any method of using a particular device or system, unless otherwise indicated or limited, is intended to inherently include disclosure, as embodiments of the invention, of the utilized features and implemented capabilities of such device or system.

Correspondingly, for example, some methods as disclosed herein can include securing the mounting bracket 102, 104 or 202, 204 to a frame rail or other frame member(s) of a motor vehicle, with the corresponding cage at least partly surrounding a catalytic converter. In this regard, some examples can include first securing one or more relevant mounting brackets to one or more vehicle frame members (e.g., as shown in FIGS. 6 and 11) and then securing a cage to the mounting bracket(s). In contrast, some examples can include first securing a cage to one or more mounting brackets and then securing the mounting bracket(s) to one or more vehicle frame members. Generally, such mounting brackets can be secure to a vehicle and to a cage using tamper-resistant fasteners, as also discussed above, although other configurations are possible (e.g., with welded or other connections).

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise specified or limited, directional terms are presented only with regard to the particular embodiment and perspective described. For example, reference to features or directions as “horizontal,” “vertical,” “front,” “rear,” “left,” “right,” “upper,” “lower,” and so on are generally made with reference to a particular figure or example and are not necessarily indicative of an absolute orientation or direction. However, relative directional terms for a particular embodiment may generally apply to alternative orientations of that embodiment. For example, “front” and “rear” directions or features (or “right” and “left” directions or features, and so on) may be generally understood to indicate relatively opposite directions or features for a particular embodiment, regardless of the absolute orientation of the embodiment (or relative orientation relative to environmental structures). “Lateral” and derivatives thereof generally indicate directions that are generally perpendicular to a vertical direction for a relevant reference frame.

Unless otherwise specified or limited, the terms “about” and “approximately,” as used herein with respect to a reference value, refer to variations from the reference value of ±15% or less (e.g., ±10%, ±5%, etc.), inclusive of the endpoints of the range. Similarly, the term “substantially equal” (and the like) as used herein with respect to a reference value refers to variations from the reference value of less than ±30% (e.g., ±20%, ±10%, ±5%) inclusive. Where specified, “substantially” can indicate in particular a variation in one numerical direction relative to a reference value. For example, “substantially less” than a reference value (and the like) indicates a value that is reduced from the reference value by 30% or more, and “substantially more” than a reference value (and the like) indicates a value that is increased from the reference value by 30% or more.

Also as used herein, ordinal numbers are used for convenience of presentation only and are generally presented in an order that corresponds to the order in which particular features are introduced in the relevant discussion. Accordingly, for example, a “first” feature may not necessarily have any required structural or sequential relationship to a “second” feature, and so on. Further, similar features may be referred to in different portions of the discussion by different ordinal numbers. For example, a particular feature may be referred to in some discussion as a “first” feature, while a similar or substantially identical feature may be referred to in other discussion as a “third” feature, and so on.

As used herein, unless otherwise defined or limited, the terms “inboard” and “outboard” refer to a relative relationship (e.g., a lateral distance) between one or more objects or structures and a centerline of the power machine, along a lateral side of the power machine. For example, a first structure that is inboard of a second structure is positioned laterally offset from the second structure so that a distance between the first structure and the centerline of the power machine is less than a distance between the second structure and the centerline of the power machine. Conversely, a first structure that is outboard of a second structure is positioned laterally offset from the second structure so that a distance between the first structure and the centerline of the power machine is greater than a distance between the second structure and the centerline of the power machine.

Similarly, as used herein, unless otherwise defined or limited, the terms “interior” and “exterior” refers to a relative relationship (e.g., a lateral distance) between one or more structures (e.g., a sub-structure) and a centerline of a reference structure (e.g., a main structure) that extends in a front-to-back direction or between first and second ends of the reference structure. For example, an interior structure is disposed closer to a centerline of a reference structure than an exterior structure. In this regard, an outboard structure of a subassembly of a power machine may also be an exterior structure. In contrast, an exterior structure of a subassembly, relative to a centerline of the subassembly, may not necessarily be outboard of other components of the subassembly.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “only one of,” or “exactly one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of one or more of each of multiple of the listed elements. For example, the phrases “a plurality of A, B, or C” and “two or more of A, B, or C” indicate options of: one or more A and one or more B; one or more B and one or more C; one or more A and one or more C; and one or more A, one or more B, and one or more C.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. A catalytic converter guard system for inhibiting access to a catalytic converter on a motor vehicle, the catalytic converter guard system comprising:
a set of mounting brackets; and
a cage including:
an input guard plate with a first cutout;
an output guard plate with a second cutout; and
a bottom plate coupled to the input guard plate and the output guard plate;
the set of mounting brackets being coupled to the cage and configured to couple to a frame of a motor vehicle to support the cage relative to the motor vehicle so that the input guard plate is positioned adjacent an input of the catalytic converter to align the first cutout to receive an input exhaust pipe therethrough, the output guard plate is positioned adjacent an output of the catalytic converter to align the second cutout to receive an output exhaust pipe therethrough, and the bottom plate is positioned to extend beneath the catalytic converter.

2. The catalytic converter guard system of claim 1, wherein the set of mounting brackets includes a first mounting bracket and a second mounting bracket, wherein at least one of the first or second mounting brackets is configured to be secured at an inboard-facing side of a frame rail of the motor vehicle to support the cage.

3. The catalytic converter guard system of claim 2, wherein at least one of the first or second mounting brackets are secured to the inboard-facing side of the frame rail with a set of tamper-resistant fasteners.

4. The catalytic converter guard system of claim 2, wherein at least one of the first or second mounting brackets is configured to be secured to an exhaust hanger coupled to the frame rail.

5. The catalytic converter guard system of claim 2, wherein the first mounting bracket is configured to be secured at the inboard-facing side of the frame rail and the second mounting bracket is configured to extend around the frame rail to couple the cage thereto.

6. The catalytic converter guard system of claim 5, wherein the second mounting bracket includes a fixed section attached to the bottom plate and a removable section, removably attached to the fixed section.

7. The catalytic converter guard system of claim 6, wherein the fixed section is configured to extend alongside an outboard-facing side and over a top side of the frame rail and the removable section is configured to be secured to the fixed section to extend along the inboard-facing side of the frame rail.

8. The catalytic converter guard system of claim 1, wherein at least one of the input guard plate, the output guard plate, or the bottom plate have a plurality of apertures.

9. The catalytic converter guard system of claim 1, further comprising a first side guard plate and a second side guard plate opposite the first side guard plate, the first and second side guard plates being coupled to the input guard plate, the output guard plate, and the bottom plate.

10. The catalytic converter guard system of claim 9, wherein the set of mounting brackets extends from the cage adjacent to the first side guard plate and a height of the first side guard plate above the bottom plate is smaller than a height of the second side guard plate above the bottom plate.

11. A catalytic converter guard system for protecting a catalytic converter on a motor vehicle, the catalytic converter guard system comprising:
a catalytic converter guard that includes:
a set of mounting brackets; and
a bottom wall coupled to the set of mounting brackets; and
a plurality of tamper-resistant fasteners;
the catalytic converter guard being secured to the motor vehicle, with at least one mounting bracket of the set of mounting brackets coupled to a frame rail of the motor vehicle with the plurality of tamper-resistant fasteners and the bottom wall extending beneath the catalytic converter.

12. The catalytic converter guard system of claim 11, wherein the bottom wall has a plurality of apertures.

13. The catalytic converter guard system of claim 11, wherein at least one mounting bracket of the set of mounting brackets extends around the frame rail.

14. The catalytic converter guard system of claim 13, wherein at least one mounting bracket of the set of mounting brackets is fastened to an inboard-facing side of the frame rail.

15. The catalytic converter guard system of claim 11, wherein at least one mounting bracket of the set of mounting brackets engages an exhaust hanger coupled to the frame rail.

16. The catalytic converter guard system of claim 11, wherein the bottom wall forms a bottom side of a five-sided box that further includes four side walls extending from the bottom wall.

17. The catalytic converter guard system of claim 16, wherein the four side walls include an input guard wall with an input cutout that admits an input exhaust pipe therethrough, an output guard wall with an output cutout that admits an output exhaust pipe therethrough, a left guard wall, and a right guard wall; and
wherein the input guard wall, the output guard wall, the left guard wall, the right guard wall, and the bottom wall are formed from a single sheet of metal.

18. A method of installing a catalytic converter guard system to protect a catalytic converter on a motor vehicle, the method comprising:
coupling a set of mounting brackets to a cage of a catalytic converter guard, the cage including an input guard plate with a first cutout, an output guard plate with a second cutout, and a bottom plate coupled to the input guard plate and the output guard plate; and
coupling the set of mounting brackets to a frame of the motor vehicle to support the cage relative to the motor vehicle;
wherein, with the set of mounting brackets coupled to the cage and to the frame of the motor vehicle, the input guard plate is positioned adjacent an input of the catalytic converter to align the first cutout to receive an input exhaust pipe therethrough, the output guard plate is positioned adjacent an output of the catalytic converter to align the second cutout to receive an output exhaust pipe therethrough, and the bottom plate is positioned to extend beneath the catalytic converter.

19. The method of claim 18, wherein coupling the set of mounting brackets to the frame of the motor vehicle includes fastening a first mounting bracket to an inboard-facing side of a frame rail of the motor vehicle.

20. The method of claim 19, wherein coupling the set of mounting brackets to the frame of the motor vehicle includes fastening a second mounting bracket to extend around the frame rail.
